(19) United States
(12) Patent Application Publication
(10) Pub. No.: US 2007/0277987 A1
(43) Pub. Date: Dec. 6, 2007

(54) POWER TOOL, BATTERY PACK, AND METHOD OF OPERATING THE SAME

(76) Inventors: Gary D. Meyer, Waukesha, WI (US); Michael Phillips, Milwaukee, WI (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 11/753,954

(22) Filed: May 25, 2007

Related U.S. Application Data
(60) Provisional application No. 60/808,651, filed on May 26, 2006.

(51) Int. Cl. B25B 21/02

(52) U.S. Cl. 173/1; 173/217

(57) ABSTRACT

An electrical combination. The electrical combination includes a power tool having a housing supporting a motor, the motor being operable to drive a tool element and including a hand grip, a battery, and a locking assembly supported by one of the battery and the housing of the power tool for selectively securing the battery to the housing. The locking assembly includes a movable locking member and an actuator movable relative to one of the battery and the housing to move the locking member. The actuator moves along both a first path and a second path different from the first path between a locking position, in which the locking member secures the battery to the housing, and an unlocked position, in which the battery is removable from the power tool.

### RELATED APPLICATIONS

This application claims the benefit of prior filed, co-pending Provisional Patent Application No. 60/808,651, the entire content of which is hereby incorporated by reference.

### FIELD OF THE INVENTION

The present invention relates to power tools and battery packs, and, more particularly, to a latch for a battery pack.

### SUMMARY

In some embodiments, the invention provides an electrical combination an electrical combination. The electrical combination includes a power tool having a housing supporting a motor, the motor being operable to drive a tool element and including a hand grip, a battery, and a locking assembly supported by one of the battery and the housing of the power tool for selectively securing the battery to the housing. The locking assembly includes a movable locking member and an actuator movable relative to one of the battery and the housing to move the locking member. The actuator moves along both a first path and a second path different from the first path between a locking position, in which the locking member secures the battery to the housing, and an unlocked position, in which the battery is removable from the power tool.

In other embodiments, the invention provides a power tool. The power tool includes a housing supporting a motor, a drive mechanism driven by the motor and operable to drive a tool element, and a locking assembly. The locking assembly includes a locking member and an actuator. The locking member is movable with respect to the housing between a locked position in which the locking member secures a battery to the housing and an unlocked position in which the battery is removable from the housing. The actuator is movable with respect to the housing and includes a ramped surface engageable with the locking member to move the locking member between the locked position and the unlocked position.

In some embodiments, the invention provides a method of operating a power tool. The method includes the acts of securing a battery to a connecting structure of the power tool, transferring power form the battery to a motor of the power tool to drive a tool element, and moving an actuator of a locking assembly. The locking assembly includes the actuator movable with respect to the housing to move a locking member. The actuator moves along a first path and a second path different from the first path between a locking position, in which the locking member secures the battery to the housing, and an unlocked position, in which the battery is removable from the power tool.

In other embodiments, the invention provides a method of operating a power tool. The method includes the acts of securing a battery to a connecting structure of the power tool, transferring power form the battery to a motor of the power tool to drive a tool element, and moving an actuator of a locking member relative to the housing to move the locking member from a locked position toward an unlocked position and removing the power tool. The locking member maintains the actuator in an unlocked position after the battery is removed, wherein the locking member secures the battery to the housing in a locked position, and in which the battery is removable from the power tool in an unlocked position.

Other aspects of the invention will become apparent by consideration of the detailed description and accompanying drawings.

### BRIEF DESCRIPTION OF THE DRAWINGS

FIG. 1 is a side view of an electrical combination including a power tool and a battery pack.

FIG. 2A is a first rear perspective view of the battery pack shown in FIG. 1.

FIG. 2B is a second rear perspective view of the battery pack shown in FIG. 1.

FIG. 2C is a first front perspective view of the battery pack shown in FIG. 1.

FIG. 2D is a second front perspective view of the battery pack shown in FIG. 1.

FIG. 2E is a cross-sectional view of the battery pack shown in FIG. 1.

FIG. 3 is a perspective view of an actuator of the power tool shown in FIG. 1.

FIG. 4 is a perspective view of a locking member of the power tool shown in FIG. 1.

FIG. 5 is a partial cross-sectional view of the power tool shown in FIG. 1.

FIGS. 6-17 illustrate a locking arrangement of the electrical combination shown in FIG. 1 in a number of positions including a locked position and an unlocked position.

FIGS. 18-21 are schematic views of an electrical combination including a battery locking arrangement and showing the locking arrangement in a number of positions including a locked position and an unlocked position.

FIG. 22 is a partial cross-sectional view of an electrical combination having a battery locking arrangement and showing the locking arrangement in an unlocked position.

FIG. 23 is a partial cross-sectional view of the electrical combination shown in FIG. 22 with the locking arrangement in a locked position.

FIG. 24 is a cross-sectional view of an electrical combination including a power tool and a battery pack.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” and “having” and variations thereof herein is meant to encompass the items listed thereafter and equivalents thereof as well as additional items.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In addition, it is to be understood that phraseology and terminology used herein with reference to device or element orientation (such as, for example, terms like “front,” “rear,” “top,” “bottom,” “lower”, “up,” “down,” etc.) are only used to simplify description of the present invention, and do not alone indicate or imply that the device or element referred to must have a particular orientation. The elements of the present invention can be installed and operated in any orientation desired. In addition, terms such as “first” and “second are used herein for purposes of description and are not intended to indicate or imply relative importance or significance.

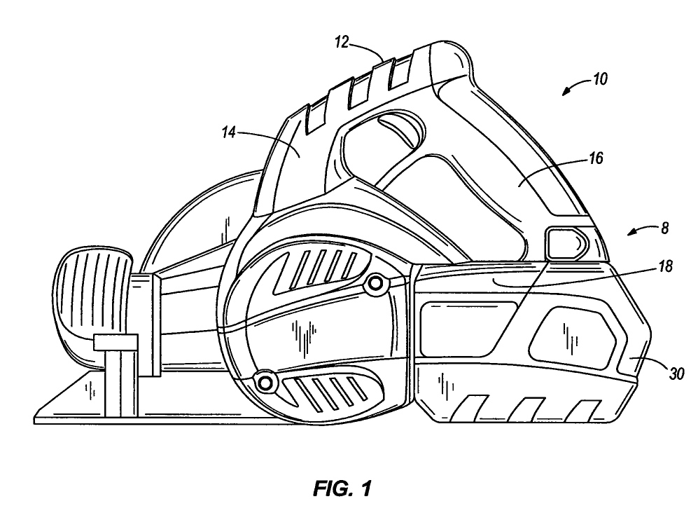

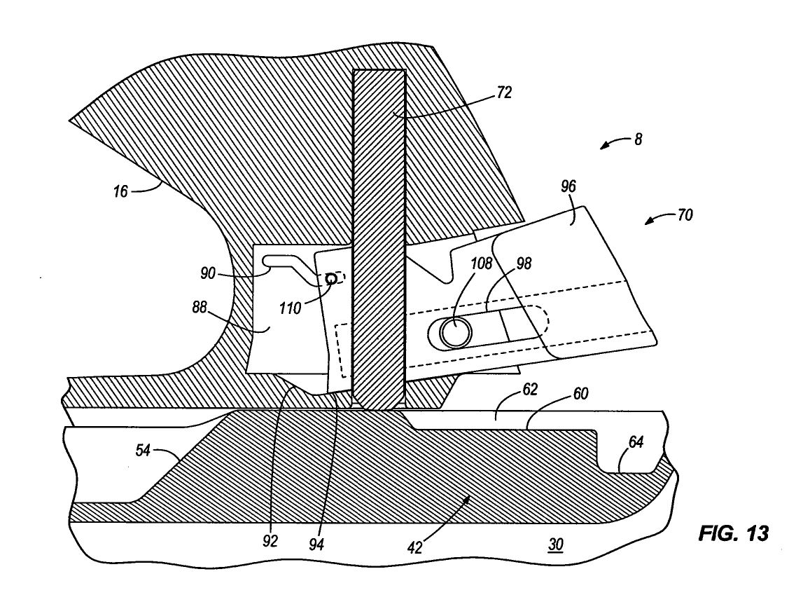

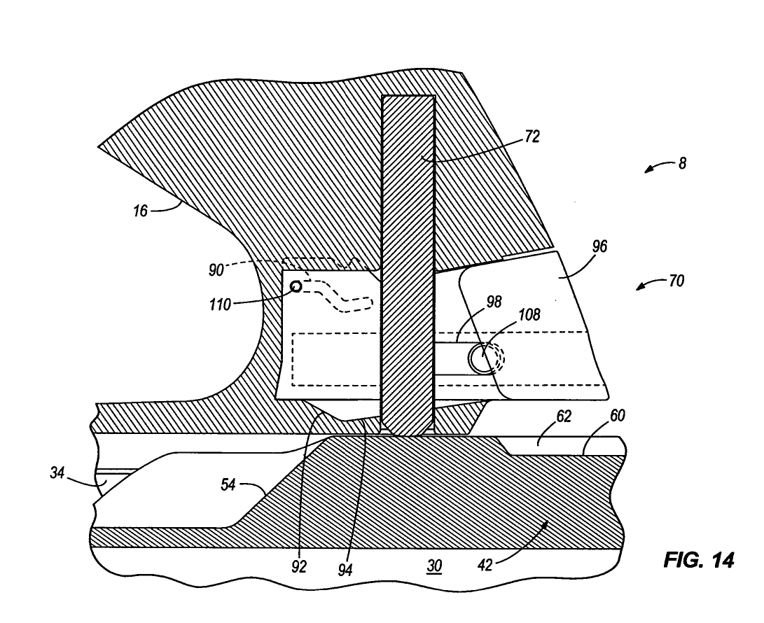

FIGS. 1-17 illustrate an electrical combination 8. As shown in FIGS. 1-17, the electrical combination 8 can include a power tool 10, such as, for example, a circular saw, and a battery pack 30. In other embodiments, the power tool 10 can be another hand-held power tool, such as, for example, a reciprocating saw, a hammer drill, a router, a drill, a screwdriver, a grinder, a sander, etc.

The power tool 10 includes a housing assembly 12 having a body 14 and a main operator's handle portion or hand grip 16 connected to a rearward portion 18 of the body 14. The body 14 houses a drive mechanism, a motor, and a spindle (not shown). Together, the drive mechanism, the motor, and the spindle are operable to rotate a tool element (not shown) generally about a tool axis for working on a workpiece (also not shown). In other embodiments, the drive mechanism, the motor, and the spindle can also or alternatively reciprocate the tool element along the tool axis for working on a workpiece.

In the illustrated embodiment of FIGS. 1-17, the battery pack 30 is removably supported below the hand grip 16 on a connecting configuration 32. As shown in FIGS. 5 and 14-17, the connecting configuration 32 can include grooves 34 and projections 36, which are operable to inter-engage a connecting configuration 42 of the battery pack 30. In the illustrated embodiment of FIGS. 1-17, grooves 34 extend horizontally along a lower portion of the connecting configuration 32 adjacent outwardly extending projections 36.

In other embodiments, the connecting configuration 32 and the elements of the connecting configuration 32 can have other positions and orientations with respect to the hand grip 16. For example, the connecting configuration 32 can be located on a rearward surface of the hand grip 16. In still other embodiments, the connecting configuration 32 can be located on other portions of the power tool body 14, such as, for example, on an upper surface, a side surface, or a forward surface of the body 14.

The connecting configuration 32 of the power tool 10 can also include a terminal assembly 44 positioned between forward ends of the grooves 34 and projections 36 and electrically connected to an electrical circuit, which extends through the power tool 10 and is electrically connected to the motor 28. The terminal assembly (partially shown in FIG. 5) 44 can include a number of outwardly extending terminals (not shown). For example, in some embodiments, the terminal assembly 44 can include a negative terminal, a positive terminal, and a communication terminal. In other embodiments, the terminal assembly 44 can include two or more of each of the negative, positive, and communication terminals. In other embodiments, the terminal assembly 44 can include only negative and positive terminals.

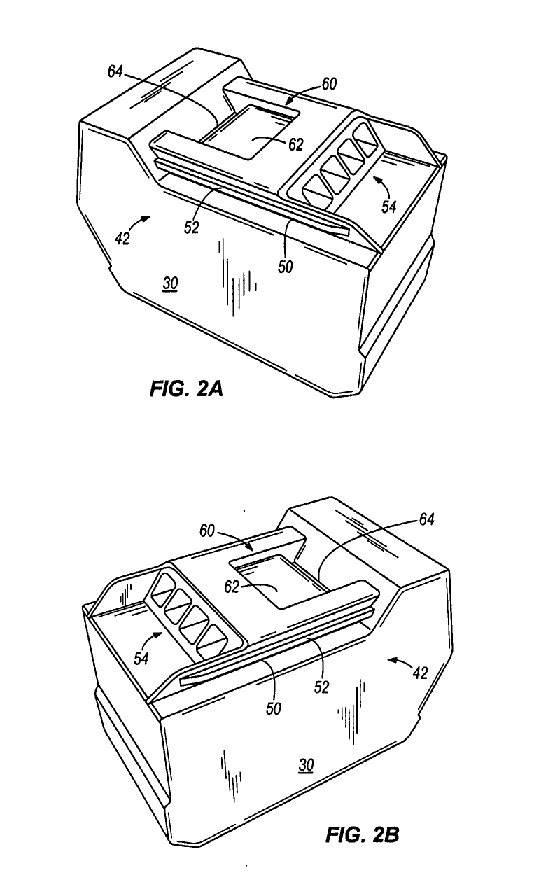

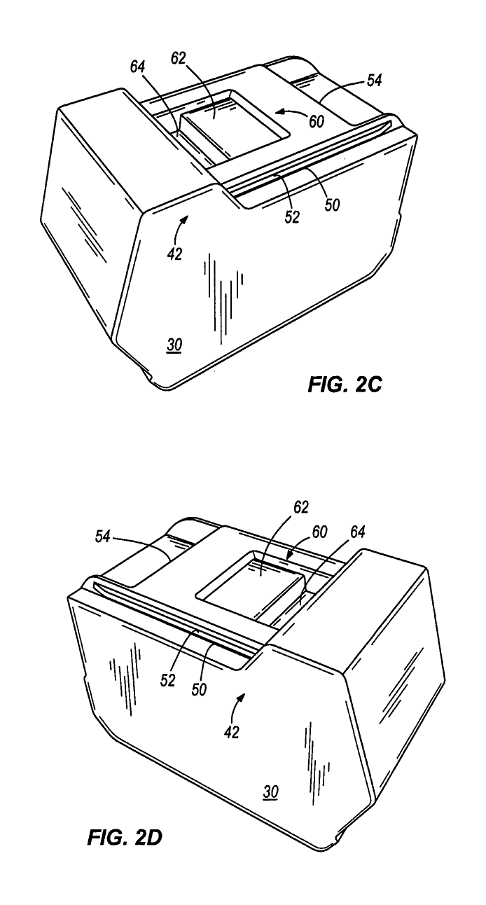

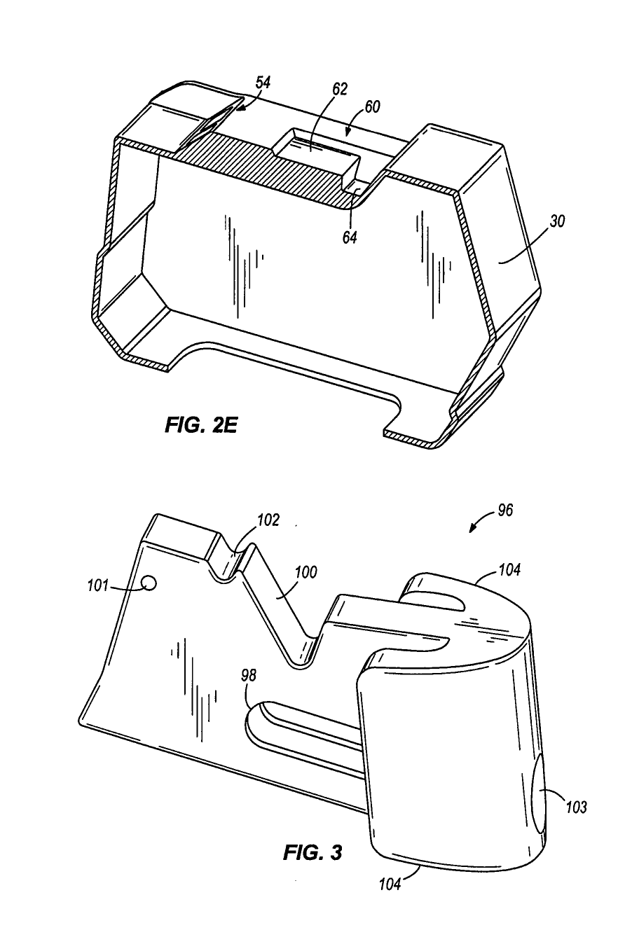

As shown in FIGS. 2A-2D, the connecting configuration 42 of the battery pack 30 can include grooves 50 and projections 52, which are operable to inter-engage with the grooves 34 and projections 36 on the connecting configuration 32 of the housing assembly 12 to removably support the battery pack 30 on the power tool 10. In the illustrated embodiment of FIGS. 1-17, the grooves 50 extend horizontally along an upper portion of the connecting configuration 42 adjacent to the outwardly extending projections 52. In other embodiments, the grooves 50 and projections 52 can have other relative positions and orientations within the connecting configuration 42 of the battery pack 30.

The connecting configuration 42 can also include a terminal assembly 54 positioned on an upper surface of the battery pack 30 between forward ends of the grooves 50 and projections 52. The terminal assembly 54 can be electrically connected to the electrical circuit. In some embodiments, the terminal assembly 54 can include a number of inwardly extending or female terminals. For example, the terminal assembly 54 can includes a negative terminal, a positive terminal, and a communication terminal. In other embodiments, the terminal assembly 54 can include two or more of each of the negative, positive, and communication terminals. In other embodiments, the terminal assembly 54 can include only negative and positive terminals.

The connecting configuration 42 of the battery pack 30 can also include a locking recess 60 positioned on an upper surface of the battery pack 30 between the grooves 50 and projections 52. In the illustrated embodiment of FIGS. 1-17, the locking recess 60 can open upwardly (i.e., toward the connecting configuration 32 of the power tool 10 when the battery pack 30 is connected to the power tool 10). As shown in FIG. 2, the locking recess 60 can include a shallow region 62 and a deep region 64, each of which is discussed in greater detail below.

As the battery pack 30 is connected to the connecting configuration 32 of the power tool 10, the grooves 50 and projections 52 on the connecting configuration 42 of the battery pack 30 inter-engage with the grooves 34 and the projections 36 on the connecting configuration 32 of the power tool 10. As the battery pack 30 is moved onto the connecting configuration 32 of the power tool 10, the terminals of the terminal assembly 44 are electrically connected to the terminals of the battery terminal assembly 54.

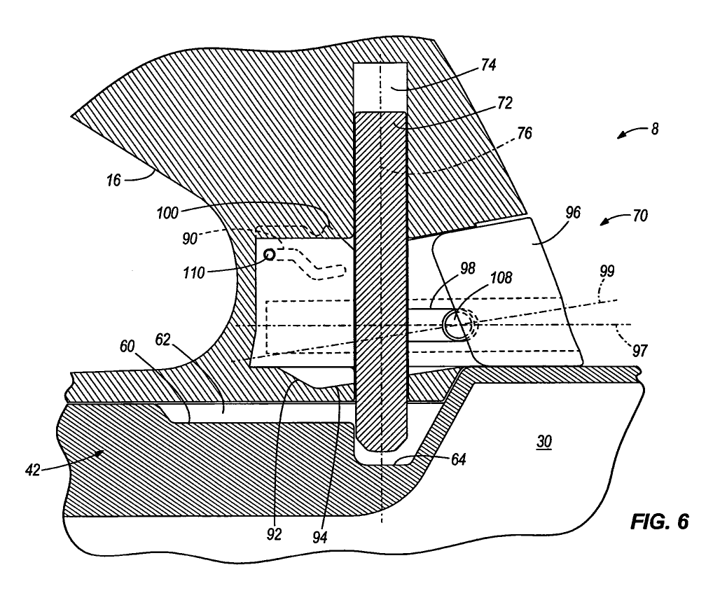

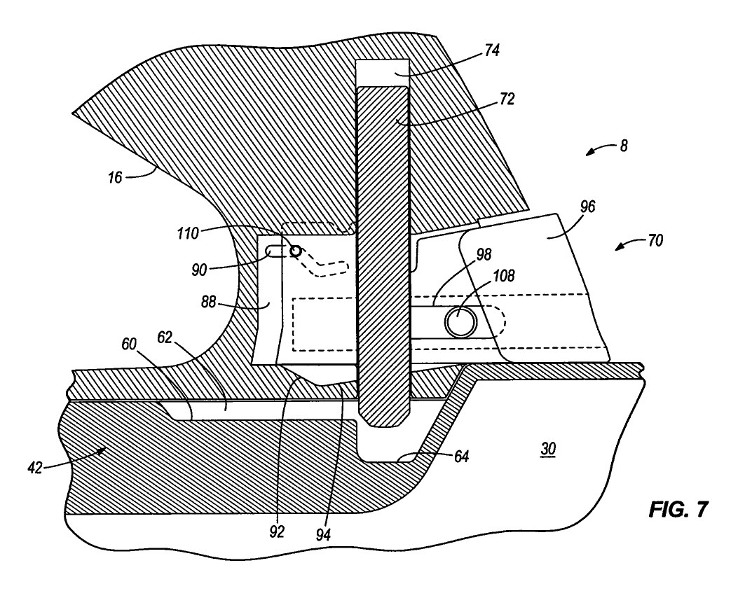

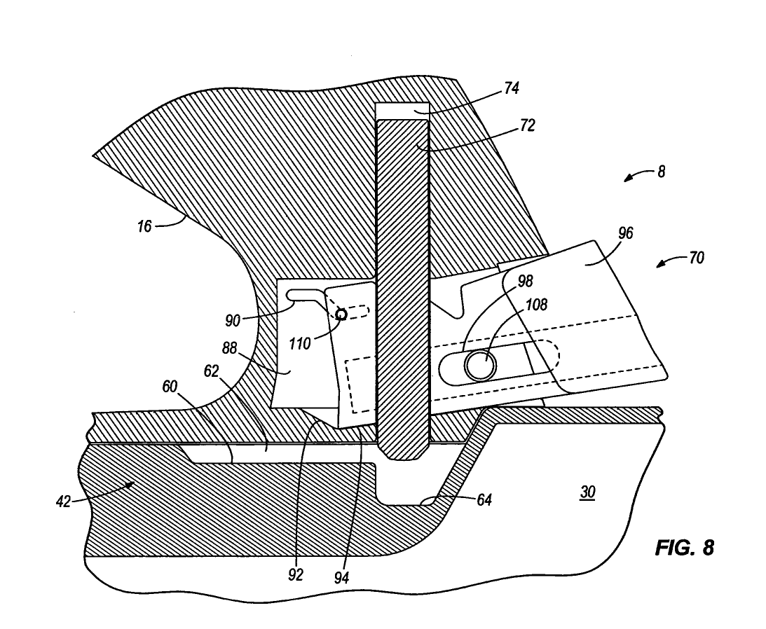

In some embodiments, such as the illustrated embodiment of FIGS. 1-17, the power tool 10 can include a locking assembly 70 for locking the battery pack 30 to the power tool 10. In the illustrated embodiment, the locking assembly 70 can include a movable projection or locking member 72 supported in the first recess 74 in the body 14. As shown in FIGS. 5-17, the first recess 74 extends downwardly through the hand grip 16 and opens toward the connecting configuration 32 of the power tool 10. During operation and as explained in greater detail below, the locking member 72 is movable axially through the first recess 74 along a first locking axis 76 (see FIG. 6), which is generally perpendicular to a battery insertion axis 78 defined by the grooves 34 and projections 36 of the power tool 10.

As best shown in FIG. 4, the locking member 72 can include a central aperture 80 defined in part by a sloped surface 82. In the illustrated embodiment of FIGS. 1-17, the sloped surface 82 extends from an upper surface of the aperture 80 toward the bottom of the locking member 72. The locking member 72 can also include an aperture 84 for receiving a spring or other biasing member (not shown) to bias the locking member 72 toward a locked position as described in greater detail below. In some embodiments, the locking member 72 can be biased toward an unlocked position.

A second recess 88 extends substantially horizontally through the hand grip 16 and opens through a rear end of the hand grip 16. In some embodiments, such as the illustrated embodiment of FIGS. 1-17, the second recess 88 can include ramps 92, 94. An actuator 96 is supported in the second recess 88 of the hand grip 16 for movement relative to the hand grip 16 along a second locking axis 97 and a third locking axis 99, which is explained in greater detail below (see FIG. 6).

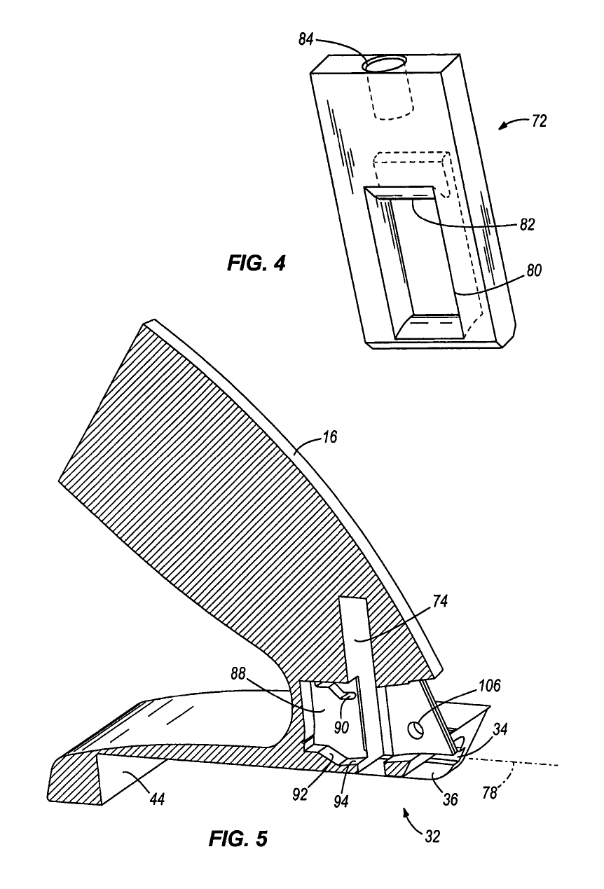

As best shown in FIG. 3, the actuator 96 can include a guide slot 98 and an aperture 101 that extend through a central portion of the actuator 96. The actuator 96 can also include a camming surface 100 and a locking recess 102 located on an upper surface of the actuator 96. The actuator 96 can also include a central chamber 103 extending through the actuator 96 to a specified depth.

In the illustrated embodiment of FIGS. 1-17, the actuator 96 can be positioned on the rearward end of the hand grip 16 so that the actuator 96 can be easily grasped with a single hand and so that an operator can use either a left or right hand to grasp the actuator 96. In some embodiments, the actuator 96 can have other relative orientations and positions. In still other embodiments, the power tool 10 can include two or more actuators 96. In some such embodiments, the actuator 96 can include a gripping surface 104 for engagement by an operator's fingers.

In the illustrated embodiment of FIGS. 1-17, a third recess 106 can extend through a rearward portion of the hand grip 16 and can open into the second recess 88. As best shown in FIGS. 6-17, a pin 108 can extend outwardly from the third recess 106 to engage the guide slot 98 in the actuator 96. The pin 108 can be fixed relative to the hand grip 16 and, in combination with the guide slot 98, at least partially defines a travel path for the actuator 96. In some embodiments, a spring or other biasing member (not shown) can be positioned in the chamber 103 between the pin 108 and a rear surface of the chamber 103 to bias the actuator 96 toward the hand grip 16, and thus bias the locking assembly 70 toward the locked position.

In the illustrated embodiment of FIGS. 1-17, the second recess 88 can include a guide slot 90. The guide slot 90 can receive a guide pin 110, which extends outwardly from the aperture 101 in the actuator 96. The guide pin 110 can be secured to the actuator 96 and can be configured to slide along the guide slot 90. The guide slot 90 can be shaped or contoured to at least partially define a travel path of the actuator 96.

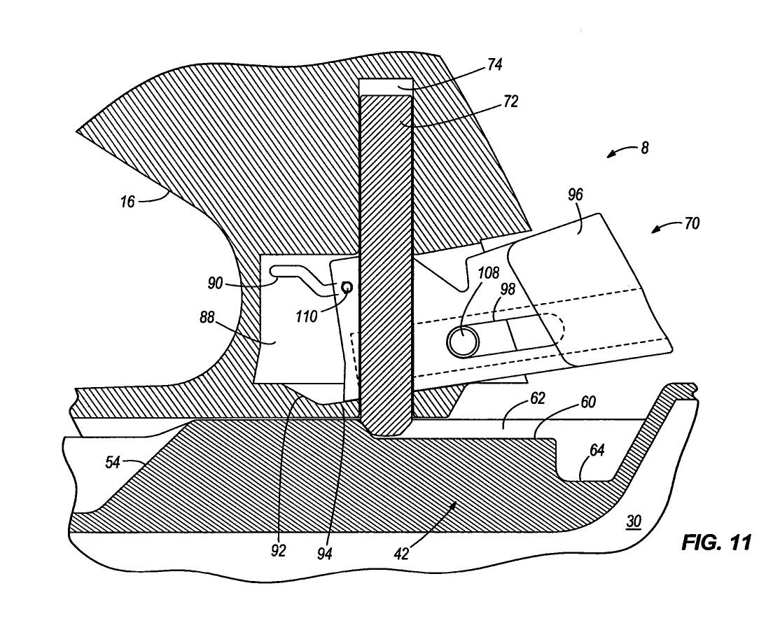

In operation, the actuator 96 can slide within the second recess 88 to move the locking member 72 between the locked and unlocked positions for securing and releasing the battery pack 30, respectively. FIGS. 6-10 illustrate the locking assembly 70 moving the locking member 72 from a locked position (shown in FIG. 6), in which the battery pack 30 is locked onto the power tool 10, and an unlocked position (shown in FIG. 10), in which the battery pack 30 is removable from the power tool 10. As shown in FIG. 6, the locking member 72 extends into the deep region 64 of the locking recess 60 when in the locked position.

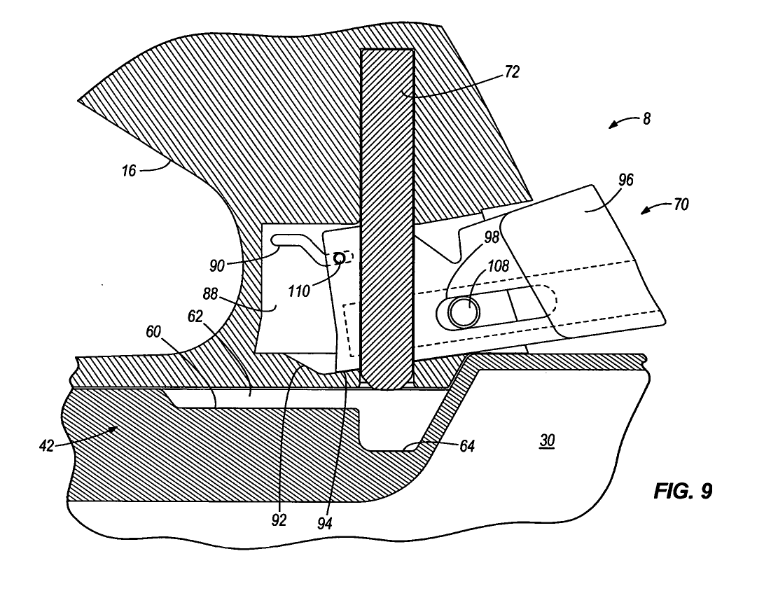

FIG. 7 illustrates the actuator 96 being moved rearwardly and away from the hand grip 16. It can be seen that the camming surface 100 on the actuator 96 engages the sloped surface 82 of the locking member 72 such that as the actuator 96 moves rearwardly away from the hand grip 16, the locking member 72 is forced upwardly through the first recess 74 and out of the deep region 64 of the locking recess 60.

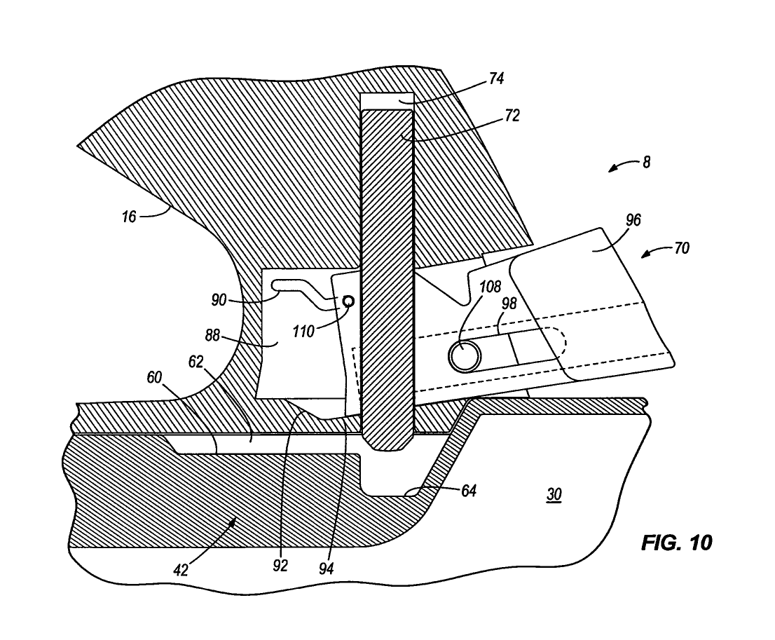

FIGS. 8 and 9 illustrate the actuator 96 tilting about the second locking axis 97 while being pulled away from the hand grip 16 along the second locking axis 97. The tilting can be caused by the guide pin 110 following the guide slot 90, and the bottom surface of the actuator 96 following the ramp 92. The actuator 96 can move along the third locking axis 99 while being tilted.

FIG. 10 illustrates the locking assembly 70 in the unlocked position. The guide pin 110 has reached the end of the guide slot 90, and the bottom edge of the sloped surface 82 has been forced over the camming surface 100 and into the locking recess 102 in the actuator 96. When the bottom edge of the sloped surface 82 is resting in the locking recess 102, the bottom of the locking member 72 can be maintained at substantially the same level as the shallow region 62 of the locking recess 60 and the locking member 72 can be retained in the unlocked position. As mentioned above, the locking member 72 can be biased toward the locked position.

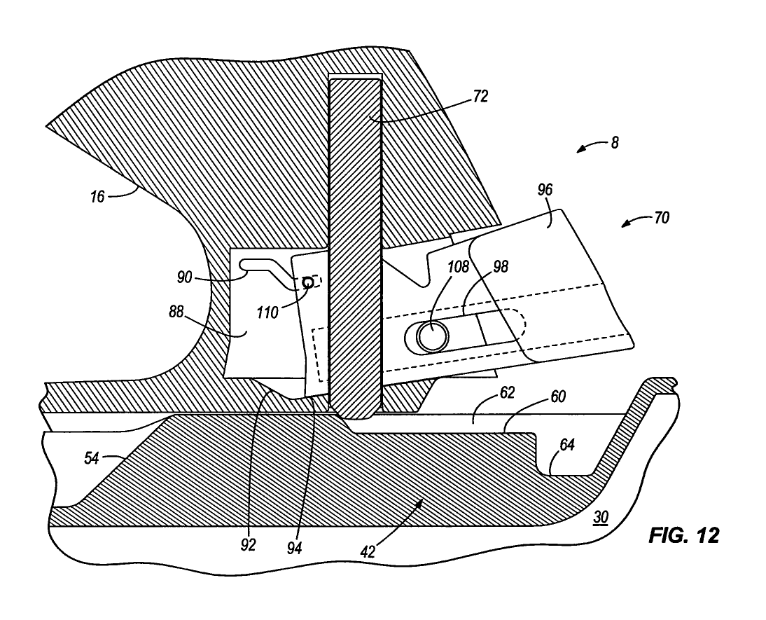

FIGS. 11-17 illustrate the locking assembly 70 in an unlocked position and the battery pack 30 being removed from the connecting configuration 32 on the power tool 10. FIG. 11 illustrates the battery pack 30 partially removed from the connecting configuration 32. In this position, the locking member 72 can contact the forward edge of the locking recess 60 as the battery pack 30 is removed.

As shown in FIGS. 12-14, when the locking member 72 contacts the forward edge of the locking recess 60, the locking member 72 can move upwardly into the first recess 74, allowing the battery pack 30 to be removed. Moving the locking member 72 upwardly can cause the bottom edge of the sloped surface 82 to move above the locking recess 102, allowing the actuator 96 to move forwardly through the second recess 88. If the actuator 96 is biased forwardly, as described above, the actuator 96 can move back into the second recess 88 without operator assistance.

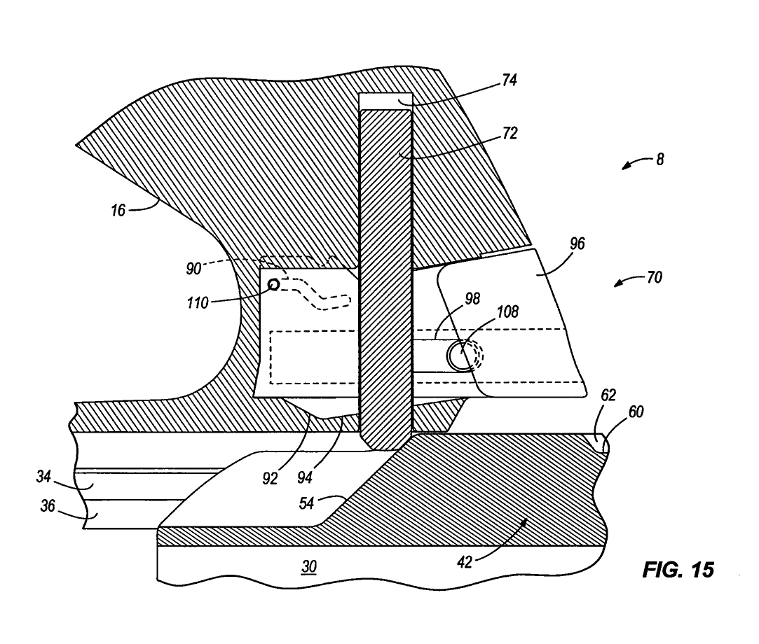

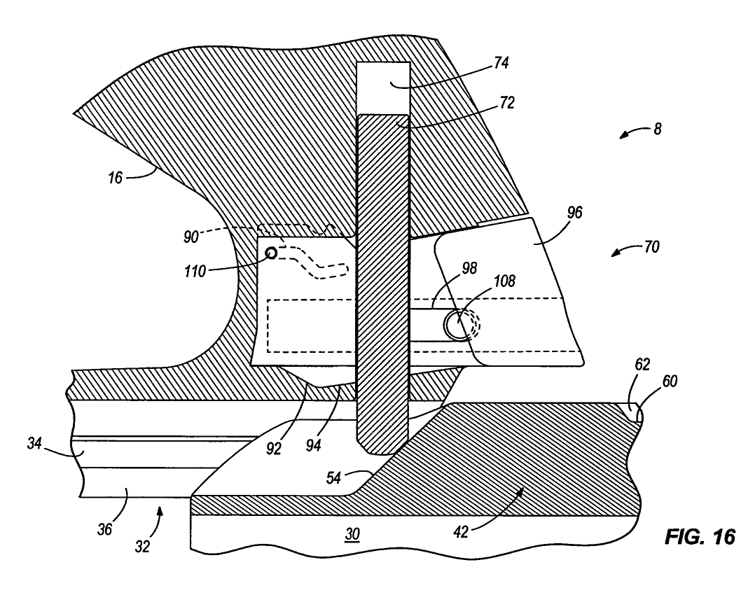

As shown in FIGS. 15-17, when the battery pack 30 is completely removed from the connecting configuration 32 of the power tool 10, the locking member 72 can return to a fully extended position, similar to the locked position shown in FIG. 6. As best shown in FIGS. 15-16, the locking member 72 can gradually return to the extended position while following a front surface of the battery terminal 54 as the battery pack 30 is removed from the power tool 10. When the battery pack 30 is installed on the power tool 10, the locking member 72 is in the extended position as shown in FIG. 17, and can be forced upwardly into the first recess 74 by following the front surface of the battery terminal 54. To complete installation of the battery pack 30 on the power tool 10, the procedure illustrated in FIGS. 6-17 is followed in reverse. In some embodiments, the locking member 72 can be held in a completely or partially retracted position within the hand grip 16 when the battery pack 30 is removed from the power tool 10.

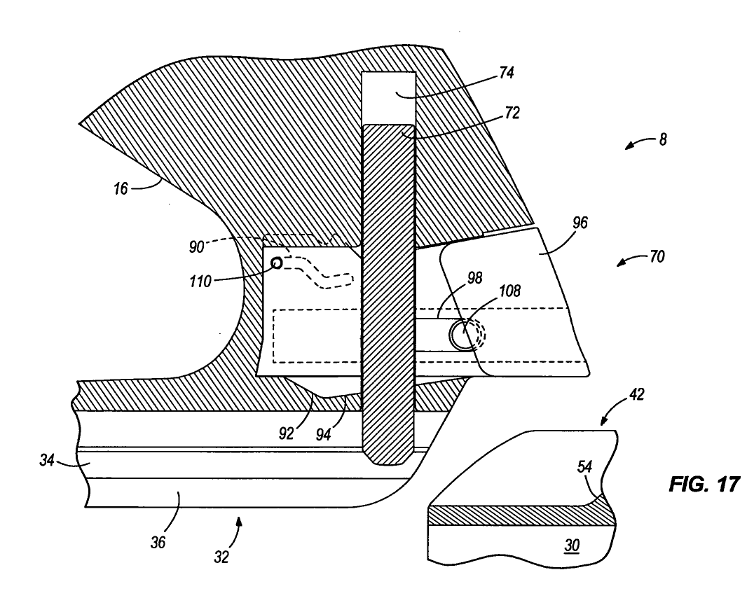

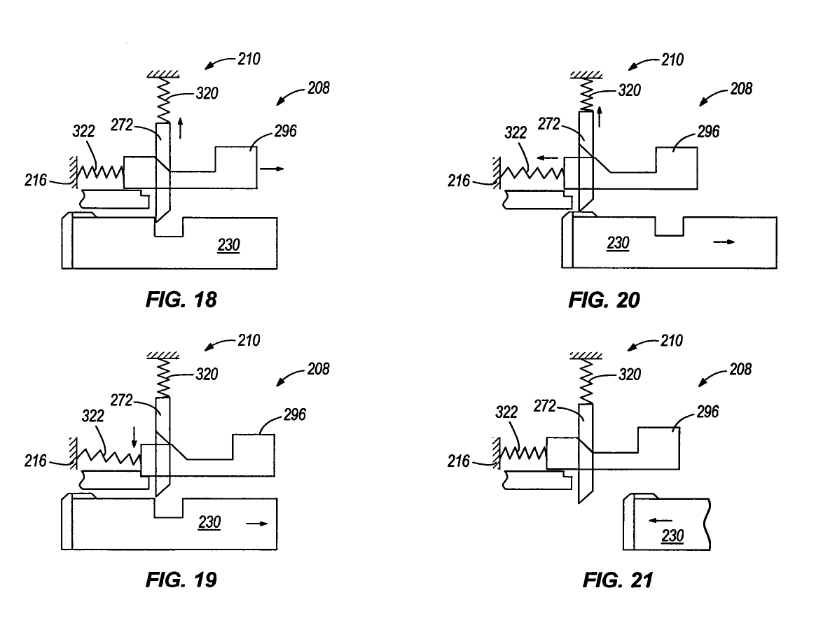

FIGS. 18-21 illustrate another embodiment of an electrical combination 208 including a power tool 210 and a battery pack 230 according to the present invention. The electrical combination 208 shown in FIGS. 18-21 is similar in many ways to the illustrated embodiments of FIGS. 1-17 described above. Accordingly, with the exception of mutually inconsistent features and elements between the embodiment of FIGS. 18-21 and the embodiments of FIGS. 1-17, reference is hereby made to the description above accompanying the embodiments of FIGS. 1-17 for a more complete description of the features and elements (and the alternatives to the features and elements) of the embodiment of FIGS. 18-21. Features and elements in the embodiment of FIGS. 18-21 corresponding to features and elements in the embodiments of FIGS. 1-17 are numbered in the 200 series.

FIGS. 18-21 illustrate the battery pack 230 being removed from the power tool 210. In this embodiment, the actuator 296 does not tilt while the battery pack 230 is removed from the power tool 210. Rather, the actuator 296 and the locking member 272 move along substantially perpendicular axes while moving between locked and unlocked positions.

In some embodiments, such as the illustrated embodiment of FIGS. 18-21, the power tool 210 can also include a first biasing member (e.g., a spring or another elastic member) 320 for biasing the locking member 272 toward the locked position, and a second biasing member (e.g., a spring or another elastic member) 322 for biasing the actuator 296 forwardly toward the hand grip 216.

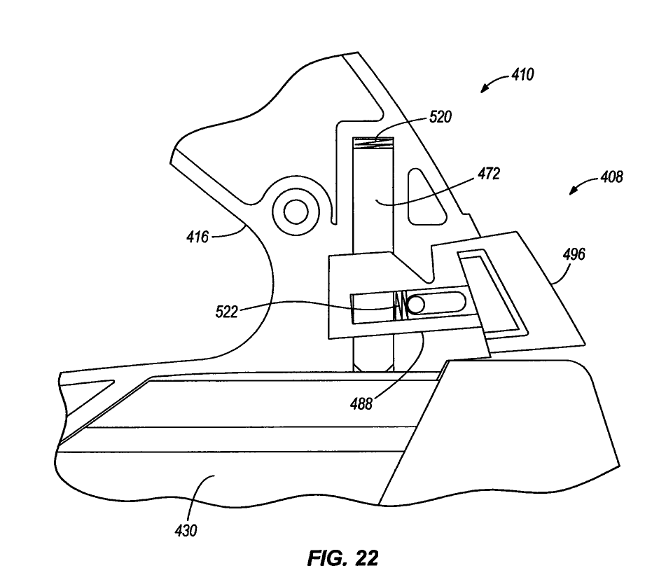

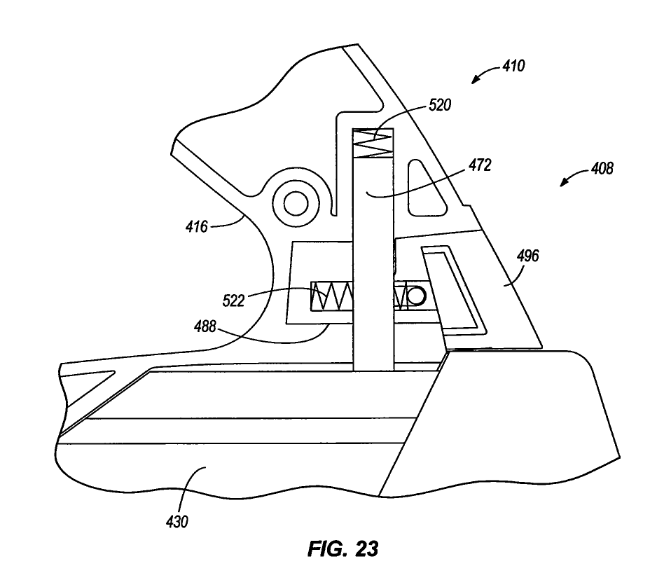

FIGS. 22 and 23 illustrate another embodiment of an electrical combination 408 including a power tool 410 and a battery pack 430 according to the present invention. The electrical combination 408 shown in FIGS. 22 and 23 is similar in many ways to the illustrated embodiments of FIGS. 1-21 described above. Accordingly, with the exception of mutually inconsistent features and elements between the embodiment of FIGS. 22 and 23 and the embodiments of FIGS. 1-21, reference is hereby made to the description above accompanying the embodiments of FIGS. 1-21 for a more complete description of the features and elements (and the alternatives to the features and elements) of the embodiment of FIGS. 22 and 23. Features and elements in the embodiment of FIGS. 22 and 23 corresponding to features and elements in the embodiments of FIGS. 1-21 are numbered in the 400 series.

FIGS. 22 and 23 illustrate the battery pack 430 being removed from the power tool 410. In this embodiment, the actuator 496 is sized to closely engage the second recess 488 of the hand grip 416. In some such embodiments, the engagement between the actuator 496 and the walls of the second recess 488 guide rearward movement of the actuator 496 along a second locking axis 97 and prevent pivoting or tilting movement of the actuator 496 with respect to the hand grip 416.

The illustrated embodiment of FIGS. 22 and 23 also includes a first biasing member 520 for biasing the locking member 472 toward the locked position, and a second biasing member 522 for biasing the actuator 496 forwardly.

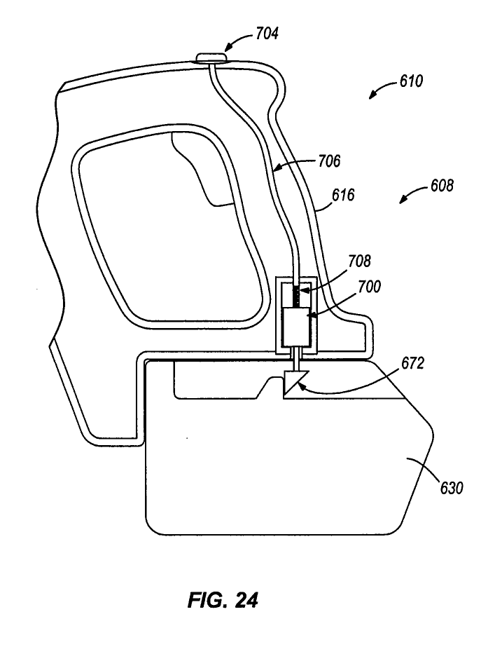

FIG. 24 illustrates another embodiment of an electrical combination 608 including a power tool 610 and a battery pack 630 according to the present invention. The electrical combination 608 shown in FIG. 24 is similar in many ways to the illustrated embodiments of FIGS. 1-23 described above. Accordingly, with the exception of mutually inconsistent features and elements between the embodiment of FIG. 24 and the embodiments of FIGS. 1-23, reference is hereby made to the description above accompanying the embodiments of FIGS. 1-23 for a more complete description of the features and elements (and the alternatives to the features and elements) of the embodiment of FIG. 24. Features and elements in the embodiment of FIG. 24 corresponding to features and elements in the embodiments of FIGS. 1-23 are numbered in the 600 series.

As shown in FIG. 24, the battery pack 630 is secured to the power tool 610 with the locking member 672 as described above. In the illustrated embodiment, the locking member 672 can be connected to an actuator 700 and can be biased toward the locked position by a biasing member 702. In the illustrated embodiment, the actuator 700 is a solenoid. In other embodiments, other electronic and/or electromechanical controls and elements can also or alternatively be used.

In the illustrated embodiment of FIG. 24, the actuator 700 maintains the locking member 672 in the locked position. When the actuator 700 is activated, the actuator 700 is operable to move the locking member 672 upwardly and out of engagement with the battery pack 630.

As shown in FIG. 24, electrical wires 706 can electrically connect a switch assembly 704 to the actuator 700. When the switch 704 is activated, the actuator 700 can move the locking member 672 toward the unlocked position.

Although particular embodiments of the present invention have been shown and described, other alternative embodiments will be apparent to those skilled in the art and are within the intended scope of the present invention.

What is claimed is:

1. An electrical combination comprising:
a power tool having a housing supporting a motor, the motor being operable to drive a tool element, and including a hand grip;
a battery; and
a locking assembly supported by one of the battery and the housing of the power tool for selectively securing the battery to the housing, the locking assembly including a movable locking member and an actuator movable relative to one of the battery and the housing to move the locking member, wherein the actuator moves along both a first path and a second path different from the first path between a locking position, in which the locking member secures the battery to the housing, and an unlocked position, in which the battery is removable from the power tool.

2. The electrical combination of claim 1, wherein the first path is substantially linear and the second path is substantially arcuate.

3. The electrical combination of claim 2, wherein the battery is selectively movable with respect to the housing in a direction of movement to remove the battery from the housing and wherein the first path is substantially parallel to the direction of movement of the battery with respect to the power tool housing.

4. The electrical combination of claim 3, wherein the locking member is movable in an axial direction, wherein the axial direction is substantially perpendicular to the direction of movement of the battery with respect to the power tool housing.

5. The electrical combination of claim 4, wherein the actuator has a ramp surface configured to engage a ramp surface of the locking member.

6. The electrical combination of claim 2, wherein the actuator is movable in a direction of movement to remove the battery from the housing and wherein the actuator is pivotable to move the locking member to the unlocked position.

7. A power tool, the power tool comprising:
a housing supporting a motor;
a drive mechanism driven by the motor and operable to drive a tool element; and
a locking assembly including
a locking member movable with respect to the housing between a locked position in which the locking member secures a battery to the housing and an unlocked position in which the battery is removable from the housing; and
an actuator movable with respect to the housing and including a ramped surface engageable with the locking member to move the locking member between the locked position and the unlocked position.

8. The power tool of claim 7, wherein the locking member includes a ramp surface.

9. The power tool of claim 8, wherein the ramp surface of the actuator is engageable with the ramp surface of the locking member.

10. The power tool of claim 7, wherein the actuator moves relative to the housing to move a locking member, wherein the actuator moves along a first path and a second path different from the first path.

11. The power tool of claim 10, wherein the first path is substantially linear and the second path is substantially arcuate.

12. The power tool of claim 11, wherein the first path is substantially parallel to a direction of movement of the battery with respect to the power tool housing.

13. The power tool of claim 12, wherein the locking member is movable in an axial direction, wherein the axial direction is substantially perpendicular to the direction of movement of the battery with respect to the power tool housing.

14. A method of operating a power tool, the method comprising the acts of:
securing a battery to a connecting structure of the power tool;
transferring power from the battery to a motor of the power tool to drive a tool element; and
moving an actuator of a locking assembly, wherein the locking assembly includes the actuator movable with respect to the housing to move a locking member, wherein the actuator moves along a first path and a second path different from the first path between a locking position, in which the locking member secures the battery to the housing, and an unlocked position, in which the battery is removable from the power tool.

15. The method of claim 14, wherein the first path is substantially linear and the second path is substantially arcuate.

16. The method of claim 15, wherein the first path is substantially parallel to a direction of movement of the battery with respect to the power tool housing.

17. The method of claim 16, wherein the locking member is movable in an axial direction, wherein the axial direction is substantially perpendicular to the direction of movement of the battery with respect to the power tool housing.

18. The method of claim 17, wherein the actuator has a ramp surface configured to engage a ramp surface of the locking member.

19. A method of operating a power tool, the method comprising the acts of:
securing a battery to a connecting structure of the power tool;
transferring power from the battery to a motor of the power tool to drive a tool element; and
moving an actuator of a locking member relative to the housing to move the locking member from a locked position toward an unlocked position and removing the power tool, the locking member maintaining the actuator in an unlocked position after the battery is removed, wherein the locking member secures the battery to the housing in a locked position, and in which the battery is removable from the power tool in an unlocked position.

20. The method of claim 19, wherein the actuator includes a ramp surface and the locking member includes a ramp surface.

21. The power tool of claim 20, wherein the ramp surface of the actuator is engageable with the ramp surface of the locking member.

22. The power tool of claim 19, wherein the actuator moves relative to the housing to move a locking member, wherein the actuator moves along a first path and a second path different from the first path.

23. The power tool of claim 22, wherein the first path is substantially linear and the second path is substantially arcuate.

24. The power tool of claim 23, wherein the first path is substantially parallel to a direction of movement of the battery with respect to the power tool housing.

25. The power tool of claim 24, wherein the locking member is movable in an axial direction, wherein the axial direction is substantially perpendicular to the direction of movement of the battery with respect to the power tool housing.
